(19) United States
(12) Patent Application Publication
(10) Pub. No.: US 2004/0034130 A1
(43) Pub. Date: Feb. 19, 2004

(54) Polycarbonate composition having excellent releasability from mold

(76) Inventors: Yuichi Kageyama, Yamaguchi (JP); Masumi Hirata, Yamaguchi (JP); Takanori Yamoshi, Yamaguchi (JP); Wataru Funakoshi, Yamaguchi (JP); Katsushi Sasaki, Yamaguchi (JP)

Correspondence Address: SUGHRUE MION, PLLC, 2100 PENNSYLVANIA AVENUE, N.W., WASHINGTON, DC, 20037, US

(21) Appl. No.: 10/433,329

(22) PCT Filed: Oct. 2, 2001
(86) PCT No.: PCT/JP01/08679

(51) Int. Cl. C08K 5/15

(52) U.S. Cl. 524/107

(57) ABSTRACT

An aromatic polycarbonate composition which is suitable for use in the production of an optical molded article such as an optical disk or lens and has excellent heat stability and releasability at the time of molding. This composition comprises 100 parts by weight of an aromatic polycarbonate obtained by reacting an aromatic dihydroxy compound with a carbonic acid diester in the presence of at least one ester exchange catalyst selected from the group consisting of an alkali metal compound and an alkali earth metal compound, 0.0001 to 0.3 part by weight of an epoxy compound and 0.015 to 0.3 part by weight of an aromatic compound having at least four benzene rings in the molecule.

### FIELD OF THE INVENTION

The present invention relates to a polycarbonate composition having excellent mold releasability, a process for producing an injection molded article, a critical surface tension modifier for use in the injection molded process, a substrate for an optical recording medium and an optical recording medium.

### PRIOR ART

A polycarbonate is an engineering plastic which is excellent in terms of color, transparency and mechanical strength. In recent years, the application of the polycarbonate has been diversified and the polycarbonate has been processed into various molded articles. As it has excellent mechanical strength in particular, it is used in large quantities as a material for thin molded articles having a high surface area ratio, such as optical disk substrates and housings for electric appliances. The molded articles are generally formed by injection molding using a metal mold. In this molding method, it has been apprehended that when the mold releasability of a molded article is poor in the step of removing the molded article, the production efficiency is reduced, which is a serious problem when the production scale is large.

Particularly in the case of an optical disk substrate, the flowability of a resin is generally improved by increasing the cylinder temperature of an injection molding machine to 350 to 400° C. in order to transfer a signal carved on a stamper to a polycarbonate substrate accurately. Therefore, the temperature of a metal mold to which the stamper is mounted must be set to a high temperature of 80 to 120° C. However, when the temperature of the metal mold is high, there arise such problems as a reduction in the mold releasability of a polycarbonate molded article, nonuniform release and poor transferability. To prevent these, the metal mold must be fully cooled before the molded article is removed from the metal mold. If the metal mold is fully cooled, the molding cycle will be long and productivity will be low. For the above reason, the development of a polycarbonate having excellent mold releasability in injection molding has been strongly desired in recent years.

It has been known that it is effective to add a release agent in order to improve the releasability of a polycarbonate. Various compounds called “lubricant” are generally known as a release agent. JP-B47-41092 (the term “JP-B” as used herein means an “examined Japanese patent publication”) proposes the addition of an ester or partial ester of a higher aliphatic carboxylic acid with a higher aliphatic alcohol or polyhydric alcohol as a release agent.

As known already, the addition of a release agent is not preferred from the viewpoints of costs and an increase in the number of steps and it is apprehended that the release agent will exert a bad influence on the characteristic features of a polycarbonate such as the color, transparency and mechanical strength of the produced polymer. In view of the above, the efficient method of improving the mold releasability of a polycarbonate without adding a release agent in order to produce a molded article simply at a low cost is strongly desired.

### SUMMARY OF THE INVENTION

It is an object of the present invention to provide a polycarbonate composition having excellent mold releasability, particularly mold releasability in injection molding.

It is another object of the present invention to provide a polycarbonate composition having excellent thermal stability in molding process in addition to mold releasability.

It is still another object of the present invention to provide a polycarbonate composition having a low content of the residual phenol and the above excellent properties.

It is a further object of the present invention to provide a critical surface tension modifier suitable for use in the polycarbonate composition of the present invention.

It is a still further object of the present invention to provide a substrate for an optical recording medium, which is made from the polycarbonate composition of the present invention.

It is a still further object of the present invention to provide an optical recording medium comprising the substrate for an optical recording medium of the present invention.

It is a still further object of the present invention to provide a process for producing an injection molded article, for example, a substrate for an optical recording medium, from a polycarbonate by ensuring excellent releasability from a metal mold.

Other objects and advantages of the present invention will become apparent from the following description.

According to the present invention, firstly, the above objects and advantages of the present invention are attained by an aromatic polycarbonate composition comprising:

(A) 100 parts by weight of an aromatic polycarbonate obtained by reacting an aromatic dihydroxy compound with a carbonic acid diester in the presence of at least one ester exchange catalyst selected from the group consisting of an alkali metal compound and an alkali earth metal compound;

(B) 0.0001 to 0.3 part by weight of an epoxy compound represented by the following formula (I):

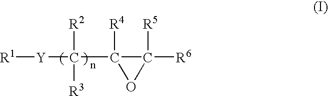

wherein R¹ is an aliphatic hydrocarbon group having 10 to 40 carbon atoms, R² to R⁶ are each independently a hydrogen atom or aliphatic hydrocarbon group having 1 to 10 carbon atoms, or R² or R³ and R⁵ or R⁶, together with the carbon atoms to which they are blended, may be bonded together to form a 5- or 6-membered ring, Y is an ether bond (—O—), ester bond (—COO— or —OCO—) or carbonate bond (—OCOO—), and n is an integer of 1 to 5; and

(C) 0.015 to 0.3 part by weight of a first aromatic compound represented by the following formula (II):

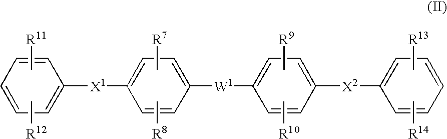

wherein R⁷, R⁸, R⁹ and R¹⁰ are each independently a group selected from the group consisting of a hydrogen atom, alkyl group having 1 to 10 carbon atoms, aryl group having 6 to 20 carbon atoms and aralkyl group having 7 to 20 carbon atoms, R¹¹, R¹², R¹³ and R¹⁴ are each independently a member selected from the group consisting of a hydrogen atom and alkyl group having 1 to 10 carbon atoms, W¹ is a member selected from the group consisting of an alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group, and X¹ and X² are each independently an ether bond (—O—), ester bond (—COO— or —OCO—) or carbonate bond (—OCOO—).

According to the present invention, secondly, the above objects and advantages of the present invention are attained by a critical surface tension modifier for aromatic polycarbonate molded articles, composed of an epoxy compound represented by the above formula (I), or use of an epoxy compound represented by the above formula (I) for adjusting the critical surface tension of an aromatic polycarbonate molded article.

According to the present invention, thirdly, the above objects and advantages of the present invention are attained by a critical surface tension modifier for aromatic polycarbonate molded articles, composed of a first aromatic compound represented by the above formula (II), or use of a first aromatic compound represented by the above formula (II) for adjusting the critical surface tension of an aromatic polycarbonate molded article.

According to the present invention, in the fourth place, the above objects and advantages of the present invention are attained by a substrate for an optical recording medium, comprising the aromatic polycarbonate composition of the present invention.

According to the present invention, in the fifth place, the above objects and advantages of the present invention are attained by an optical recording medium comprising the above substrate of the present invention and an optical recording layer formed on one side of the substrate directly or through an intermediate layer.

According to the present invention, in the sixth place, the above objects and advantages of the present invention are attained by a process for producing an injection molded article of an aromatic polycarbonate, comprising adhering a first aromatic compound represented by the above formula (II) to the inner surface in contact with an aromatic polycarbonate of an injection metal mold which accepts the aromatic polycarbonate in an amount of 0.005 to 0.1 mg per 1 cm² of the inner surface of the metal mold.

### DESCRIPTION OF THE PREFERRED EMBODIMENT

The aromatic polycarbonate used in the present invention is produced by reacting an aromatic dihydroxy compound with a carbonic acid diester in the presence of at least one ester exchange catalyst selected from the group consisting of an alkali metal compound and an alkali earth metal compound.

Examples of the aromatic dihydroxy compound include 2,2-bis(4-hydroxyphenyl)propane (to be referred to as “bisphenol A” hereinafter), bis(2-hydroxyphenyl)methane, bis(4-hydroxyphenyl)methane, 1,1-bis(4-hydroxyphenyl)ethane, 1,1-bis(4-hydroxyphenyl)propane, 2,2-bis(2-hydroxyphenyl)propane, 2,2-bis(4-hydroxy-3,5-dimethylphenyl)propane, 2,2-bis(4-hydroxy-3,5-dibromophenyl)propane, 2,2-bis(4-hydroxy-3-methylphenyl)propane, 2,2-bis(4-hydroxyphenyl)pentane, 3,3-bis(4-hydroxyphenyl)pentane, 1,1-bis(4-hydroxyphenyl)cyclohexane, bis(4-hydroxyphenyl)ether, bis(4-hydroxyphenyl)sulfide, bis(4-hydroxyphenyl)sulfone and compounds having an alkyl group or aryl group substituted for an aromatic ring. They may be used alone or in combination of two or more. Out of these, 2,2-bis(4-hydroxyphenyl)propane (bisphenol A) is preferred because it has stability as a monomer and a low total content of impurities and can be acquired easily.

Examples of the carbonic acid diester include diphenyl carbonate, dinaphthyl carbonate, bis(diphenyl)carbonate, dimethyl carbonate, diethyl carbonate and dibutyl carbonate. Out of these, diphenyl carbonate is preferred from an economical point of view.

The alkali metal compound or alkali earth metal compound used as a catalyst is, for example, a hydroxide, hydrocarbon compound, carbonate, acetate, nitrate, nitrite, sulfite, cyanate, thiocyanate, stearate, borohydride, benzoate, phosphate, acidic phosphate, bisphenol or phenol salt of an alkali metal or an alkali earth metal.

Illustrative examples of the alkali metal compound or alkali earth metal compound include sodium hydroxide, potassium hydroxide, lithium hydroxide, cesium hydroxide, rubidium hydroxide, francium hydroxide, sodium bicarbonate, potassium bicarbonate, lithium carbonate, sodium carbonate, potassium carbonate, lithium carbonate, cesium carbonate, sodium acetate, potassium acetate, lithium acetate, sodium nitrate, potassium nitrate, rubidium nitrate, lithium nitrate, sodium nitrite, potassium nitrite, rubidium nitrite, lithium nitrite, sodium sulfite, potassium sulfite, lithium sulfite, sodium cyanate, potassium cyanate, lithium cyanate, sodium thiocyanate, potassium thiocyanate, lithium thiocyanate, cesium thiocyanate, sodium stearate, potassium stearate, lithium stearate, cesium stearate, sodium borohydride, potassium borohydride, lithium borohydride, sodium phenylborate, sodium benzoate, potassium benzoate, lithium benzoate, disodium hydrogenphosphate, dipotassium hydrogenphosphate, dilithium hydrogenphosphate, disodium salts, dipotassium salts, dilithium salts, dicesium salts, monosodium salts, monopotassium salts, monocesium salts, sodium potassium salts and sodium lithium salts of bisphenol A and sodium salts, potassium salts, lithium salts and cesium salts of phenol. Out of these, cesium compounds and rubidium compounds are preferred.

The alkali metal compound preferably contains at least one member selected from the group consisting of a cesium compound and a rubidium compound, and cesium and/or rubidium metal element atoms contained in the alkali metal compound account for preferably 0.001 to 100%, more preferably 90 to 100% of all the alkali metal element atoms.

The amount of the polymerization catalyst is preferably 0.05 to 5 μchemical equivalents, more preferably 0.07 to 3 μchemical equivalents, particularly preferably 0.07 to 2 μchemical equivalents based on 1 mol of the aromatic dihydroxy compound.

The alkali metal compound and the alkali earth metal compound are preferably used in combination with a nitrogen-containing basic compound and/or a phosphorus-containing basic compound. A polycarbonate having excellent color and thermal stability can be obtained from this combination at a high polymerization rate.

Illustrative examples of the nitrogen-containing basic compound include ammonium hydroxides having an alkyl, aryl or alkylaryl group such as tetramethylammonium hydroxide (Me₄NOH), tetraethylammonium hydroxide (Et₄NOH), tetrabutylammonium hydroxide (Bu₄NOH), benzyltrimethylammonium hydroxide (PhCH₂ (Me)₃NOH) and hexadecyltrimethylammonium hydroxide; basic ammonium salts having an alkyl, aryl or alkylaryl group such as tetramethylammonium acetate, tetraethylammonium phenoxide, tetrabutylammonium carbonate, benzyltrimethylammonium benzoate and hexadecyltrimethylammonium ethoxide; tertiary amines such as triethylamine, tributylamine, dimethylbenzylamine and hexadecyl dimethylamine; and basic salts such as tetramethylammonium borohydride (Me₄NBH₄), tetrabutylammonium borohydride (Bu₄NBH₄), tetrabutylammonium tetraphenyl borate (Bu₄NBPh₄) and tetramethylammonium tetraphenyl borate (Me₄NBPh₄).

Illustrative examples of the phosphorus-containing basic compound include phosphonium hydroxide shaving an alkyl, aryl or alkylaryl group such as tetramethylphosphonium hydroxide (Me₄POH), tetraethylphosphonium hydroxide (Et₄POH), tetrabutylphosphonium hydroxide (Bu₄POH), tetraphenylphosphonium hydroxide (Ph₄POH), benzyltrimethylphosphonium hydroxide (PhCH₂(Me)₃POH) and hexadecyltrimethylphosphonium hydroxide; and basic salts such as tetramethylphosphonium borohydride (Me₄PBH₄), tetrabutylphosphonium borohydride (Bu₄PBH₄), tetrabutylphosphonium tetraphenyl borate (Bu₄PBPh₄) and tetramethylphosphonium tetraphenyl borate (Me₄PBPh₄).

The above nitrogen-containing basic compound and/or phosphorus-containing basic compound are/is preferably used in an amount of 10 to 1,000 μchemical equivalents in terms of basic nitrogen atom or basic phosphorus atom based on 1 mol of the aromatic dihydroxy compound. The amount is more preferably 20 to 500 μchemical equivalents, particularly preferably 50 to 500 μchemical equivalents based on the same standard.

Preferably, the aromatic polycarbonate (A) used in the present invention comprises a recurring unit represented by the following formula (III) as the main recurring unit:

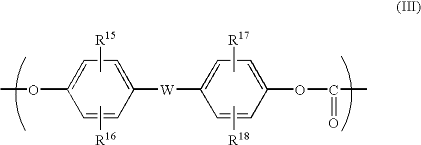

wherein R¹⁵ R¹⁶, R¹⁷ and R¹⁸ are each independently a group selected from the group consisting of a hydrogen atom, alkyl group having 1 to 10 carbon atoms, aryl group having 6 to 10 carbon atoms and aralkyl group having 7 to 20 carbon atoms, and W is a member selected from the group consisting of an alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group.

The recurring unit represented by the above formula (III) is formed through a reaction between the above aromatic hydroxy compound and carbonic acid dieter.

Specific examples of R¹⁵, R¹⁶, R¹⁷, R¹⁸ and W in the above formula (III) are given below. R¹⁵, R¹⁶, R¹⁷ and R¹⁸ are each independently a group selected from the group consisting of a hydrogen atom; alkyl group having 1 to 10 carbon atoms such as methyl, ethyl, propyl, butyl or hexyl; aryl group having 6 to 10 carbon atoms such as phenyl or naphthyl; and aralkyl group having 7 to 20 carbon atoms such as benzyl. W is a group selected from the group consisting of an alkylene group having 1 to 6 carbon atoms such as methylene, ethylene or isoprene; alkylidene group having 2 to 10 carbon atoms such as ethylidene; cycloalkylene group having 5 to 10 carbon atoms such as cycloheptylene or cyclohexylene; cycloalkylidene group having 5 to 10 carbon atoms such as cyclohexylidene; cycloalkylidene group having 5 to 10 carbon atoms such as cyclohexylidene; alkylene-arylene-alkylene group having 8 to 15 carbon atoms such as

isopropylene-phenylene-isopropylene; oxygen atom; sulfur atom; and sulfoxide group or sulfone group. Preferably, R¹⁵, R¹⁶, R¹⁷ and R¹⁸ are each a hydrogen atom or methyl group, and W is an isopropylene group or cyclohexylene group. More preferably, R¹⁵, R¹⁶, R¹⁷ and R¹⁸ are each a hydrogen atom, and W is an isopropylene group.

The viscosity average molecular weight of the aromatic polycarbonate is preferably 12,000 to 100,000, more preferably 13,000 to 28,000. When the viscosity average molecular weight is smaller than 12,000 or larger than 100,000, the releasability of a molded article obtained by injection molding tends to deteriorate even by using a critical surface tension modifier.

Further, the aromatic polycarbonate (A) preferably has a melt viscosity stability of 0.5% or less. The melt viscosity stability is a numerical value of change rate per minute obtained from an absolute value of change in melt viscosity measured at a shear rate of 1 rad/sec and a temperature of 300° C. for 30 minutes in a stream of nitrogen.

The melt viscosity stability can be obtained by adding a melt viscosity stabilizer to a polycarbonate after polymerization.

The melt viscosity stabilizer has the function of deactivating part or all of the activity of a polymerization catalyst used for the production of a polycarbonate.

The melt viscosity stabilizer may be added while the polycarbonate which is a reaction product is in a molten state or after the polycarbonate is pelletized and remolten. In the former case, the melt viscosity stabilizer may be added while the polycarbonate which is a reaction product in a reactor or extruder is in a molten state, or the melt viscosity stabilizer may be added and kneaded while the polycarbonate obtained after polymerization is pelletized through the extruder from the reactor.

Any known melt viscosity stabilizer is acceptable but a sulfonic acid compound such as an organic sulfonic acid salt, organic sulfonic acid ester, organic sulfonic anhydride or organic sulfonic acid betain is preferably used because it is very effective in improving the physical properties such as color, heat resistance and boiling water resistance of the obtained polymer. Out of these, a phosphonium salt of sulfonic acid and/or an ammonium salt of sulfonic acid are/is preferred. Out of these, tetrabutylphosphonium dodecylbenzenesulfonate (to be abbreviated as DBSP hereinafter) and tetrabutylammonium paratoluenesulfonate are particularly preferred.

The amount of the melt viscosity stabilizer in the present invention is selected from a range of 0.05 to 20 times the chemical equivalent of the alkali metal or alkali earth metal used as a catalyst.

The production process described above may be preferably used as a process for synthesizing a critical surface tension modifier simultaneously with a melt polymerization reaction and controlling the amount of the critical surface tension modifier.

The epoxy compound contained as the component (B) in the composition of the present invention is represented by the following formula (I):

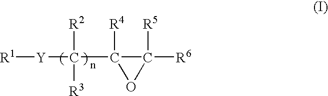

In the formula, R¹ is an aliphatic hydrocarbon group having 10 to 40 carbon atoms, R² to R⁶ are each independently a hydrogen atom or aliphatic hydrocarbon group having 1 to 10 carbon atoms, or R² or R³ and R⁵ or R⁶ may be bonded together to form a 5- or 6-membered ring together with carbon atoms bonded thereto, Y is an ether bond (—O—), ester bond (—COO— or —OCO—) or carbonate bond (—OCOO—), and n is an integer of 1 to 5.

Since the above epoxy compound (B) does not contain a hydroxyl group in the molecule, it is possible to markedly suppress an increase in the amount of the residual phenol and burn marks formed at the time of high-temperature molding by thermal decomposition caused by a reaction with the polymer, which are seen when a partial ester of a saturated monocarboxylic acid and a polyhydric alcohol is used.

In the above formula (I), R¹ is preferably a linear alkyl group having 10 to 20 carbon atoms.

The epoxy compound (B) is particularly preferably represented by the following formula (I)-1:

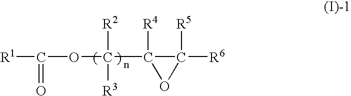

wherein R¹ to R⁶ and n are as defined in the above formula (I).

Examples of the epoxy compound include

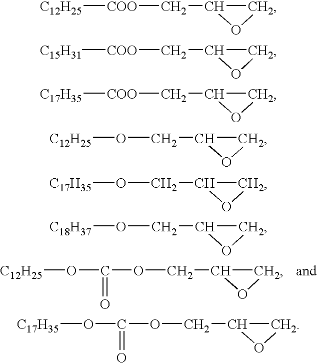

The process for synthesizing the above epoxy compound is not particularly limited and the epoxy compound is easily obtained through a commonly used organic reaction.

The amount of the epoxy compound is 0.00001 to 0.3 part by weight based on 100 parts by weight of the polycarbonate. It is preferably 0.0005 to 0.3 part by weight, more preferably 0.005 to 0.1 part by weight, much more preferably 0.007 to 0.08 part by weight, particularly preferably 0.01 to 0.07 part by weight. When the amount is outside the above range of 0.00001 to 0.3 part by weight, the heat resistance of the obtained polycarbonate resin composition tends to be low and satisfactory releasability is hardly obtained.

The first aromatic compound contained as the component (C) in the composition of the present invention is represented by the following formula (II).

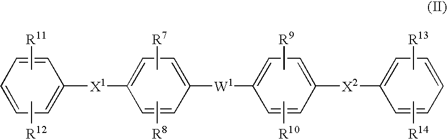

In the formula, R⁷₁ R⁸, R⁹ and R¹⁰ are each independently a group selected from the group consisting of a hydrogen atom, alkyl group having 1 to 10 carbon atoms, aryl group having 6 to 20 carbon atoms and aralkyl group having 7 to 20 carbon atoms, R¹¹, R¹², R¹³ and R¹⁴ are each independently a group selected from the group consisting of a hydrogen atom and alkyl group having 1 to 10 carbon atoms, W¹ is a member selected from the group consisting of an alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group, and X¹ and X² are each independently an ether bond (—O—), ester bond (—COO— or —OCO—) or carbonate bond (—OCOO—).

Illustrative examples of R⁷ to R¹⁴ and W¹ in the above formula (II) are obvious from examples of R¹⁵ to R¹⁸ and W in the above formula (III).

The above first aromatic compound is preferably a compound represented by the following formula (II)-1:

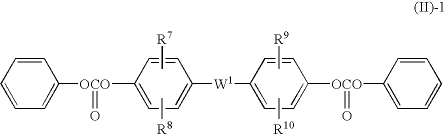

wherein R⁷ to R¹⁰ and W¹ are as defined in the above formula (II),

for example, a compound represented by the following formula:

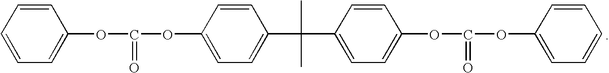

The amount of the first aromatic compound is 0.015 to 0.3 part by weight based on 100 parts by weight of the polycarbonate. It is preferably 0.015 to 0.25 part by weight, more preferably 0.015 to 0.2 part by weight, much more preferably 0.03 to 0.2 part by weight, particularly preferably 0.05 to 0.2 part by weight.

When the amount of the first aromatic compound is in the above range, preferred releasability is obtained and a molded article whose color and mechanical properties are not adversely affected is obtained.

The composition of the present invention may contain a second aromatic compound represented by the following formula (IV):

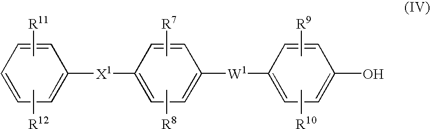

wherein R⁷ to R¹², X¹ and W¹ are as defined in the above formula (II).

The compound of the above formula (IV) is, for example, a compound represented by the following formula.

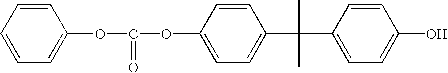

The second aromatic compound represented by the above formula (IV) is used in an amount of preferably 0.5 to 50 parts by weight, more preferably 0.5 to 2.5 parts by weight, particularly preferably 0.5 to 2.0 parts by weight based on 1 part by weight of the first aromatic compound represented by the above formula (II). When the second aromatic compound is used in the above amount, more preferred releasability is obtained.

Methods of controlling the contents of the first aromatic compound and optionally the second aromatic compound to the above ranges include one in which the compounds are synthesized and controlled simultaneously with a polymerization reaction by maintaining temperature and the degree of vacuum at appropriate levels under conditions for the early stage of a melt polymerization reaction and/or conditions for the late stage of the melt polymerization reaction for the production of a polycarbonate, one in which the compounds synthesized separately are mixed with a polycarbonate in a molten state in the final stage of polymerization, and one in which the compounds are mixed when the polycarbonate is solidified and remolten after the end of polymerization. The first method in which the compounds are synthesized and controlled during a melt polymerization reaction is preferred.

Methods of controlling the weight ratio to the above range include one in which the molar ratio of a carbonic acid diester to an aromatic dihydroxy compound at the time of charging for a polymerization reaction is increased (for example, from 1.03 to 1.10 to carry out polymerization; polymerization charge molar ratio control method) in consideration of the characteristic features of a polymerization reactor and/or one in which OH terminal groups are capped by a salicylate-based compound in accordance with a method disclosed by U.S. Pat. No. 5,696,222 at the end of a polymerization reaction.

The contents of these compounds in the polymer can be measured by known methods such as one in which an organic low-molecular compound extracted by a polymer reprecipitation method is measured by high-speed liquid chromatography to determine the amount or one in which an organic low molecular compound extracted by Soxhlet extraction using an organic solvent having high solubility for an organic low-molecular compound but no solubility for a polycarbonate and by distilling out the solvent is measured to determine the amount. The former method is more preferred.

The epoxy compound represented by the above formula (I) and the first aromatic compound represented by the above formula (II) used in the composition of the present invention have the function of adjusting the critical surface tension of an aromatic polycarbonate molded article as described above. For example, they are used to increase the critical surface tension of an aromatic polycarbonate molded article having a critical surface tension lower than about 34.8 or to reduce the critical surface tension of an aromatic polycarbonate molded article having a critical surface tension higher than about 34.8. The above value of about 34.8 is obtained by measuring critical surface tension in accordance with JIS K6768. A polycarbonate composition having a critical surface tension of, for example, 34.8±0.4 has excellent releasability and surface properties.

According to the present invention, there is also provided a critical surface tension modifier for aromatic polycarbonate molded articles, which is composed of the above epoxy compound or the first aromatic compound, making use of the above characteristic features of the above epoxy compound or the first aromatic compound.

Conventionally known additives such as a release agent, processing stabilizer, heat resistant stabilizer, antioxidant, optical stabilizer, ultraviolet light absorber, metal inactivating agent, metal soap, nucleating agent, antistatic agent and flame retardant may be added to the above aromatic polycarbonate composition of the present invention according to application purpose.

The conventionally known release agent is a partial ester compound of an aliphatic carboxylic acid with a polyhydric alcohol, that is, an ester compound having at least one unreacted and free hydroxyl group of the polyhydric alcohol.

The above aliphatic carboxylic acid is not particularly limited and may be a saturated or unsaturated aliphatic carboxylic acid. The aliphatic carboxylic acid is preferably a saturated monovalent fatty acid, particularly preferably a saturated monovalent fatty acid having 12 to 24 carbon atoms.

Examples of the aliphatic carboxylic acid include dodecylic acid, pentadecylic acid, palmitic acid, heptadecylic acid, stearic acid, nonadecanoic acid, arachic acid, behenic acid and lignoceric acid.

The above polyhydric alcohol is not particularly limited and may be divalent, trivalent, tetravalent, pentavalent or hexavalent. For example, it is preferably ethylene glycol, propylene glycol, neopentyl glycol, glycerin, trimethylolpropane or pentaerythritol, particularly preferably glycerin.

The above partial ester compound is preferably a saturated monovalent aliphatic monoglyceride and/or diglyceride having 12 to 24 carbon atoms.

The above partial ester compound is desirably used in such an amount that the weight ratio of the epoxy compound represented by the above formula (I) to the partial ester compound should become preferably 0.25 to 5, more preferably 0.42 to 1.

Examples of the processing stabilizer include 2-t-butyl-6-(3-t-butyl-2-hydroxy-5-methylbenzyl)-4-methylphenyl acrylate and 2-[1-(2-hydroxy-3,5-di-t-pentylphenyl)ethyl]-4,6-di-t-pentylphenyl acrylate.

Examples of the optical stabilizer include ultraviolet light absorbers such as benzotriazole-based compounds including 2-(3-t-butyl-2-hydroxy-5-methylphenyl)-5-chlorobenzotriazole, 2-(3,5-di-t-butyl-2-hydroxyphenyl)benzotriazole, 2-(2-hydroxy-5-methylphenyl)benzotriazole, 2-(2-hydroxy-5-t-octylphenyl)benzotriazole, 2-(3,5-di-t-pentyl-2-hydroxyphenyl)benzotriazole, 2-[2-hydroxy-3-(3,4,5,6-tetrahydrophthalimidemethyl) phenyl]benzotriazole and 2-[2-hydroxy-3,5-bis(α,α-dimethylbenzyl)phenyl] benzotriazole; benzophenone-based compounds including 2-hydroxy-4-octyloxybenzophenone and 2-hydroxy-4-methoxybenzophenone; hydroxybenzophenone-based compounds such as 2,4-di-t-butylphenyl and 3,5-di-t-butyl-4-hydroxybenzoate, and cyanoacrylate-based compounds including ethyl-2-cyano-3,3-diphenyl acrylate; and nickel-based quenchers such as nickel dibutyldithiocarbamate and [2,2′-thiobis(4-t-octylphenolate)]-2-ethylhexylamine nickel.

Examples of the metal inactivating agent include N,N′-[3-(3,5-di-t-butyl-4-hydroxyphenyl)propionyl] hydrazine.

Examples of the metal soap include calcium stearate and nickel stearate.

Examples of the nucleating agent include sorbitol-based and phosphate-based compounds such as sodium di(4-t-butylphenyl)phosphonate, dibenzylidene sorbitol and methylenebis(2,4-di-t-butylphenol)acid phosphate sodium salt.

Examples of the antistatic agent include quaternary ammonium salt-based compounds such as (β-lauramidepropyl)trimethylammonium methyl sulfate and alkyl phosphate-based compounds.

Examples of the flame retardant include halogen-containing phosphates such as tris(2-chloroethyl)phosphate, halides such as hexabromocyclododecane and decabromophenyl oxide, metal inorganic compounds such as antimony trioxide, antimony pentoxide and aluminum hydroxide, and mixtures thereof.

The above components may be added to and kneaded with a polycarbonate in a molten state or with a polycarbonate solution. More specifically, they are directly added to and kneaded with a molten polycarbonate which is the reaction product obtained after the end of a polymerization reaction in a reactor or extruder, or the obtained polycarbonate is pelletized and supplied to a single-screw or double-screw extruder together with the above components to be molten and kneaded together, or the obtained polycarbonate is dissolved in a suitable solvent (for example, methylene chloride, chloroform, toluene or tetrahydrofuran) and the above components are added to this resulting solution and stirred. In order to reduce the time of the melt state and the number of times of remelting, it is preferred to add and knead components such as a sulfonic acid compound and a cyclic compound with the molten polycarbonate obtained by melt polymerization and pelletize the resulting product.

The polycarbonate composition of the present invention can be formed into various molded articles by injection molding. Any apparatus may be used for injection molding but the set temperature of the cylinder of a molding machine is preferably 250 to 400° C. When the set temperature of the cylinder is lower than 250° C., the flowability of the polymer is low, thereby making it impossible to obtain a good molded article. Particularly in the molding of an optical disk substrate which is one of the main applications of the polycarbonate, the transferability of a stamper signal deteriorates disadvantageously. When the set temperature of the cylinder is higher than 400° C., the thermal deterioration of the polymer occurs, thereby worsening the color and mechanical properties of the polymer. The set temperature of the metal mold is preferably 50 to 140° C. When the set temperature of the metal mold is lower than 50° C., nonuniform release occurs in a molded article and when the set temperature is higher than 140° C., preferred releasability is not obtained.

According to the present invention, when the first aromatic compound represented by the above formula (II) is adhered to the inner surface in contact with the aromatic polycarbonate of an injection metal mold for accepting the aromatic polycarbonate in an amount of 0.005 to 0.1 mg per 1 cm² of the inner surface before injection molding, an injection molded article can be removed well from the metal mold by the release function of the first aromatic compound.

Molded articles of the aromatic polycarbonate composition of the present invention include electronic and communication equipment; OA equipment; optical parts such as substrates for optical recording media exemplified by lenses, prisms and optical disk substrates, and optical fibers; electronic and electric materials such as home electric appliances, illumination members and heavy electric members; mechanical materials such as car interiors and exteriors, precision machines and insulating materials; medical materials; security and protection materials; sport and leisure goods; sundry goods such as household articles; containers and package materials; and display and ornamental materials. The above optical disk substrates include 1.2 mm-thick molded substrates such as CD, LD, CD-ROM, CD-R, optical magnetic disks and phase-variable disks, substrates obtained by laminating together 1.2 mm-thick substrates, 0.6 mm-thick substrates, and DVD substrates obtained by laminating together two 0.6 mm-thick DVD molded substrates. The DVD substrates include DVD-ROM, DVD-R and DVD-RAM.

The substrate for an optical recording medium of the present invention preferably has a critical surface tension of 34.4 to 36.4.

According to the present invention, there are also provided a substrate for an optical recording medium, which is made from the polycarbonate composition of the present invention, and an optical recording medium comprising the above substrate for an optical recording medium and an optical recording layer formed on one side of the substrate directly or though an intermediate layer.

This optical recording medium may comprise a dielectric layer and a reflection layer as required like a known optical recording medium.

### EXAMPLES

The following examples are provided for the purpose of further illustrating the present invention but are in no way to be taken as limiting.

The properties of the polymer were evaluated in accordance with the following methods.

(Mold Releasability; Measurement of Release Resistance Value)

Each polymer was injection molded continuously by the M-50B molding machine of Meiki Co., Ltd. at a cylinder temperature of 380° C. and a mold temperature of 80° C., the load applied to a projection pin when the molded article was removed and the load applied to the projection pin when a blank was used were detected from the in-cylinder oil pressure of the pin, and the difference between the loads was taken as release resistance value (unit; kg/cm²). When this value was 15 or less, it was judged that the releasability of the polymer was satisfactory. For one time of measurement, 500 shots were molded continuously and the average release resistance value of 401-st to 500-th shots was taken.

(Measurement of Critical Surface Tension)

This was measured in accordance with JIS K6768. That is, the surface tension (30 to 56 dyn/cm; 330 to 560 μN/cm) of a molded plate was measured using a wetting test solution (mixed solution of formamide and ethylene glycol monomethyl ether; Wako Junyaku Co., Ltd.) and a colorant (Victoria Blue B; Wako Junyaku Co., Ltd.). 30 molded plates formed from each polymer were used, the surface tension of each plate was measured at 5 points, and the obtained measurement values were averaged.

(Heat Resistant Stability)

After the obtained polymer was retained in an injection molding machine (cylinder temperature of 340° C., mold temperature of 80° C.) for 10 minutes, a 2 mm-thick molded plate was formed from the polymer. The color difference ( [symbol] E)before and after retention was measured with the ND-1001DP color and color difference meter of Nippon Denshoku Kogyo Co., Ltd. The color difference ( [symbol] E) was measured in accordance with JIS8722 and Z8730. The measurement was made on each polymer 10 times and the obtained measurement values were averaged.

(Extraction and Determination of BPC and MPC)

As for the contents of the compounds A (BPC) and B (MPC) represented by the following formulas (1) and (2) in the polymer, low-molecular weight components extracted by a polymer re-precipitation method were measured by high-speed liquid chromatography. The polymer re-precipitation method and high-speed liquid chromatography measurement were performed by the following methods. That is, 10.0 g of each polymer was dissolved in 100 ml of methylene chloride, 900 ml of acetonitrile was added dropwise to the solution under agitation to re-precipitate a polymer, methylene chloride was distilled off under vacuum, and the precipitate was filtered by a glass filter having a pore size of 10 to 16 μm. This filtrate was measured by high-speed liquid chromatography (LC-8020 of Toso Corporation) to determine the amounts of BPC and MPC.

Using the Develosil ODS-7 column (300 mm×4 mm in diameter, constant temperature of 40° C.) for high-speed liquid chromatography, the elute was measured by changing its water/acetonitrile ratio from 6:4 to 0:10 at a detection wavelength of 253 nm to determine the amount of each component from its peak area. The treatment after extraction by the polymer re-precipitation method was made on each polymer 5 times and the measurement values were averaged.

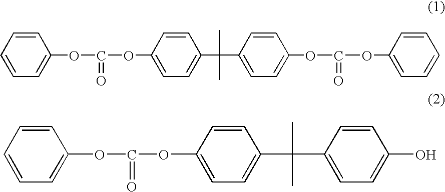

### Examples 1 to 4 and Comparative Examples 1 to 4

After bisphenol A (22,800 parts by weight), diphenyl carbonate (22,100 parts by weight) (BPA:DPC=1:1.033) and polymerization catalysts which consisted of 0.007 g (0.5 μNa) of 2Na salt of bisphenol A and 0.91 g (100μ) of tetramethylammonium hydroxide were fed to a reactor equipped with a stirrer, distillation column and decompressor and the inside of the reactor was substituted by nitrogen, the above components were dissolved at 180° C. and a reaction was carried out at an inside pressure of 100 mmHg for 30 minutes while the formed phenol was distilled off. Then the pressure was gradually reduced to 50 mmHg while the inside temperature was elevated to 200° C. to further carry out the reaction at 50 mmHg for 30 minutes while the phenol was distilled off. The temperature was further increased to 220° C. and the pressure was reduced to 30 mmHg to continue the reaction at that temperature and that pressure for 30 minutes. The temperature was increased and the pressure was reduced in the same manner to 240° C./1 mmHg, 260° C./1 mmHg and 280° C./1 mmHg or less to continue the reaction. Finally, the polymerization reaction was continued at 280° C. and 1 mmHg or less, part of the polymer was sampled when it was judged from the agitation power of the polymerization reactor that the viscosity average molecular weight of the polycarbonate became 15,300, and the reaction was continued until the viscosity average molecular weight became 15,300 while measuring the viscosity average molecular weight. Thereafter, 0.058 g (equivalent to 1 p; 2 times as an Na catalyst) of DBSP as a melt viscosity stabilizer was added, mixed and stirred at 280° C. and 1 mmHg or less for 10 minutes to deactivate and inactivate the catalyst. Subsequently, the additives shown in Table 1 below were added to and kneaded with the resulting solution in predetermined amounts and the obtained polymer was formed into strands through a die and cut by a cutter to produce pellets.

In Example 4, right before the pellets were molded from the polymer containing the above additives, a 0.1% acetone solution of BPC represented by the above formula (1) was sprayed onto the polymer contact surface of a metal mold such that the deposition of BPC after the evaporation of acetone became 0.05 mg per 1 cm² of the polymer contact surface area of the metal mold. In a molding test, the solution was sprayed in the same manner as described above each time 100 shots were molded.

Abbreviations in Table 1 stand for the following substances.

TABLE 1
R1: glycerin monostearate

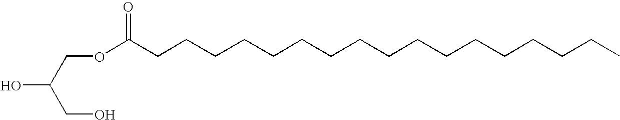

R2:

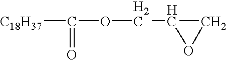

P1: tris(2,4-di-t-butylphenyl)phosphite

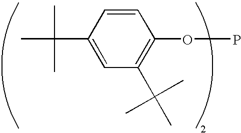

P2: trismethyl phosphate
(CH₃O)₃P═O

| | | | amount of each additive | | | | | | | | | | | |
|---|---|---|---|---|---|---|---|---|---|---|---|---|---|---|
| catalyst | | | (parts by weight × 10⁻⁴) | | | | | physical properties of polymer | | | | | | |
| | tetramethyl | alkali | release agent | | heat resistant | | | | | content | content | critical | evaluation | |
| | ammonium | metal | ester | epoxy | stabilizer | | first | | | of | of | surface | re- | |
| | hydroxide | compound | com- | com- | phosphate | | aromatic | mol- | melt | BPC | MPC | tension of | force | thermal |
| | (parts by | (parts by | pound | pound | (phosphite) | | compound | ecular | viscosity | (parts by | | molded | force | thermal |
| | weight) | weight) | R1 | R2 | P1 | P2 | BPC | weight | stability | weight × 10⁻⁴) | | article | (Gpa) | stability |
| Ex. 1 | 0.91 | sodium | — | 450 | 30 | 50 | 1500 | 15300 | 0.5% | 1600 | 1000 | 34.8 | 1.15 | 0.1 |
| | | hydroxide | | | | | | | or less | | | | | |
| | | (0.004) | | | | | | | | | | | | |
| Ex. 2 | 0.91 | cesium | — | 450 | 30 | 50 | 1500 | 15300 | 0.5% | 1600 | 1000 | 34.8 | 1.15 | 0.1 |
| | | hydroxide | | | | | | | or less | | | | | |
| | | (0.015) | | | | | | | | | | | | |
| Ex. 3 | 0.91 | sodium | 135 | 315 | 30 | 50 | 1500 | 15300 | 0.5% | 1600 | 1000 | 34.8 | 1.15 | 0.2 |
| | | hydroxide | | | | | | | or less | | | | | |
| | | (0.004) | | | | | | | | | | | | |
| Ex. 4 | 0.91 | sodium | — | 450 | 30 | 50 | *1) | 15300 | 0.5% | 1600 | 1000 | 34.8 | 1.15 | 0.2 |
| | | hydroxide | | | | | | | or less | | | | | |
| | | (0.004) | | | | | | | | | | | | |
| C. | 0.91 | sodium | 450 | 0 | 30 | 50 | 1500 | 15300 | 0.5% | 1600 | 1000 | 35.0 | 1.15 | 0.6 |
| Ex. 1 | | hydroxide | | | | | | | or less | | | | | |
| | | (0.004) | | | | | | | | | | | | |
| C. | 0.91 | cesium | 450 | 0 | 30 | 50 | 1500 | 15300 | 0.5% | 1600 | 1000 | 35.0 | 1.15 | 0.6 |
| Ex. 2 | | hydroxide | | | | | | | or less | | | | | |
| | | (0.015) | | | | | | | | | | | | |
| C. | 0.91 | sodium | 0 | 0 | 30 | 50 | 1500 | 15300 | 0.5% | 1600 | 1000 | 35.2 | 1.32 | 0.1 |
| Ex. 3 | | hydroxide | | | | | | | or less | | | | | |
| | | (0.004) | | | | | | | | | | | | |
| C. | 0.91 | sodium | 450 | 0 | 30 | 50 | 0 | 15300 | 0.5% | 100 | 1000 | 36.8 | 1.28 | 0.6 |
| Ex. 4 | | hydroxide | | | | | | | or less | | | | | |
| | | (0.004) | | | | | | | | | | | | |

Ex.: Example
C. Ex.: Comparative Example
*1) applied to a metal mold at the time of molding.

1. An aromatic polycarbonate composition comprising:
(A) 100 parts by weight of an aromatic polycarbonate obtained by reacting an aromatic dihydroxy compound with a carbonic acid diester in the presence of at least one ester exchange catalyst selected from the group consisting of an alkali metal compound and an alkali earth metal compound;
(B) 0.00001 to 0.3 part by weight of an epoxy compound represented by the following formula (I): 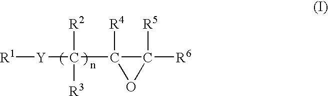
wherein R¹ is an aliphatic hydrocarbon group having 10 to 40 carbon atoms, R² to R⁶ are each independently a hydrogen atom or aliphatic hydrocarbon group having 1 to 10 carbon atoms, or R² or R³ and R⁵ or R⁶, together with the carbon atoms to which they are bonded, may be bonded together to form a 5- or 6-membered ring, Y is an ether bond (—O—), ester bond (—COO— or —OCO—) or carbonate bond (—OCOO—) and n is an integer of 1 to 5; and
(C) 0.015 to 0.3 part by weight of a first aromatic compound represented by the following formula (II): 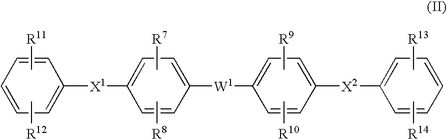
wherein R⁷, R⁸, R⁹ and R¹⁰ are each independently a group selected from the group consisting of a hydrogen atom, alkyl group having 1 to 10 carbon atoms, aryl group having 6 to 20 carbon atoms and aralkyl group having 7 to 20 carbon atoms, R¹¹, R¹², R¹³ and R¹⁴ are each independently a member selected from the group consisting of a hydrogen atom and alkyl group having 1 to 10 carbon atoms, W¹ is a member selected from the group consisting of an alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group, and X¹ and X² are each independently an ether bond (—O—), ester bond (—COO— or —OCO—) or carbonate bond (—OCOO—).

2. The aromatic polycarbonate composition of claim 1, wherein the ester exchange catalyst is an alkali metal compound and the alkali metal compound contains at least one member selected from the group consisting of a cesium compound and a rubidium compound.

3. The aromatic polycarbonate composition of claim 2, wherein the alkali metal compound contains at least one member selected from the group consisting of a cesium compound and a rubidium compound, and cesium and/or rubidium metal element atoms contained in the alkali metal compound account for 0.001 to 100% of all the alkali metal element atoms.

4. The aromatic polycarbonate composition of claim 2, wherein the alkali metal compound contains at least one member selected from the group consisting of a cesium compound and a rubidium compound, and cesium and/or rubidium metal element atoms contained in the alkali metal compound account for 90 to 100% of all the alkali metal element atoms.

5. The aromatic polycarbonate composition of claim 1, wherein the aromatic polycarbonate (A) comprises a recurring unit represented by the following formula (III) as the main recurring unit: 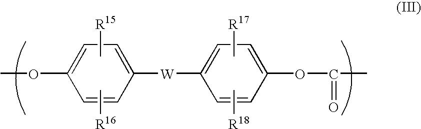
wherein R¹⁵, R¹⁶, R¹⁷ and R¹⁸ are each independently a group selected from the group consisting of a hydrogen atom, alkyl group having 1 to 10 carbon atoms, aryl group having 6 to 10 carbon atoms and aralkyl group having 7 to 20 carbon atoms, and W is a member selected from the group consisting of an alkylene group having 1 to 6 carbon atoms, alkylidene group having 2 to 10 carbon atoms, cycloalkylene group having 5 to 10 carbon atoms, cycloalkylidene group having 5 to 10 carbon atoms, alkylene-arylene-alkylene group having 8 to 15 carbon atoms, oxygen atom, sulfur atom, sulfoxide group and sulfone group.

6. The aromatic polycarbonate composition of claim 1, wherein the viscosity average molecular weight of the aromatic polycarbonate (A) is in the range of 12,000 to 100,000.

7. The aromatic polycarbonate composition of claim 1, wherein the melt viscosity stability of the aromatic polycarbonate (A) is 0.5% or less.

8. The aromatic polycarbonate composition of claim 1, wherein the epoxy compound is represented by the following formula (I)-1: 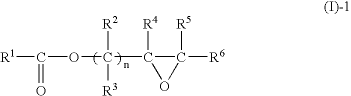
wherein R¹ to R⁶ and n are as defined in the above formula (I).

9. The aromatic polycarbonate composition of claim 1,
wherein the first aromatic compound is represented by the following formula (II)-1: 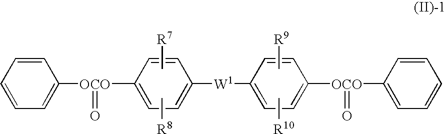
wherein R⁷ to R¹⁰ and W¹ are as defined in the above formula (II).

10. The aromatic polycarbonate composition of claim 1 which further comprises a second aromatic compound represented by the following formula (IV): 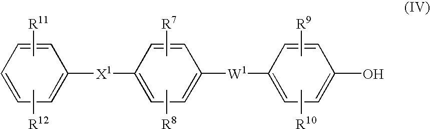
wherein R⁷ to R¹², X¹ and W¹ are as defined in the above formula (II).

11. Use of an epoxy compound represented by the above formula (I) for adjusting the critical surface tension of an aromatic polycarbonate molded article.

12. Use of claim 11 for increasing the critical surface tension of an aromatic polycarbonate molded article having a critical surface tension lower than about 34.8.

13. Use of claim 11 for reducing the critical surface tension of an aromatic polycarbonate molded article having a critical surface tension higher than about 34.8.

14. A critical surface tension modifier for an aromatic polycarbonate molded article, which is composed of an epoxy compound represented by the above formula (I).

15. Use of a first aromatic compound represented by the above formula (II) for adjusting the critical surface tension of an aromatic polycarbonate molded article.

16. Use of claim 15 for increasing the critical surface tension of an aromatic polycarbonate molded article having a critical surface tension lower than about 35.8.

17. Use of claim 15 for reducing the critical surface tension of an aromatic polycarbonate molded article having a critical surface tension higher than about 35.8.

18. A critical surface tension modifier for an aromatic polycarbonate molded article, which is composed of a first aromatic compound represented by the above formula (II).

19. A substrate for an optical recording medium, which comprises the aromatic polycarbonate composition of claim 1.

20. The substrate of claim 19 which has a critical surface tension of 34.4 to 36.4.

21. An optical recording medium comprising the substrate of claim 19 and an optical recording layer formed on one side of the substrate directly or through an intermediate layer.

22. A process for producing an injection molded article of an aromatic polycarbonate, comprising adhering a first aromatic compound represented by the above formula (II) to the inner surface in contact with an aromatic polycarbonate of an injection metal mold which accepts the aromatic polycarbonate in an amount of 0.005 to 0.1 mg per 1 cm² of the inner surface of the metal mold.
